(19) United States
(12) Patent Application Publication
(10) Pub. No.: US 2003/0075523 A1
(43) Pub. Date: Apr. 24, 2003

(54) Grinding-and-etching system for plate-like objects

(76) Inventor: Yutaka Koma, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/302,863

(22) Filed: Nov. 25, 2002

Related U.S. Application Data
(62) Division of application No. 09/589,135, filed on Jun. 8, 2000.

(30) Foreign Application Priority Data
Jun. 14, 1999 (JP) 11-166926

(51) Int. Cl. C23F 1/00; C03C 15/00

(52) U.S. Cl. 216/52; 216/67

(57) ABSTRACT

Disclosed is a grinding-and-etching system using a dry-etching for removing strains from plate-like objects such as semiconductor wafers, which are caused in grinding such objects. The system includes chuck table means (11) for fixedly holding plate-like objects, grinder means (12a, 12b) for grinding plate-like objects held on the chuck table means, washing means (13) for washing the post-grinding plate-like objects, and dry-etching means (14) for dry-etching the plate-like objects thus washed. The dry-etching does not require any strong acid which will produce an unwholesome gas to cause environmental pollution.

### BACKGROUND OF THE INVENTION

1. Field of the Invention

The present invention relates to a grinding-and-etching system for grinding very thin plate-like objects such as semiconductor wafers to a desired thickness, and for etching such wafer-thin pieces to remove therefrom any strains which appear as a result of grinding.

2. Related Arts

Semiconductor wafers each having IC, LSI or other circuit patterns formed on their front sides are ground on their rear sides to a desired thickness, and then, the semiconductor wafers are diced into square chips.

Referring to FIG. 4, a semiconductor wafer 50 having a protection tape T applied to its front side is put on a chuck table 52 with its front side down, and a grinding wheel 54 having a grindstone 53 attached to its end is rotated and lowered until it has been put in contact with the rear side 51 of the semiconductor wafer 50. The mechanical grinding thus effected is apt to cause strains due to micro-cracks or the like to appear on the rear ground side of the semiconductor wafer, thus lowering its anti-breaking strength.

To prevent appearance of such strains on the post-grinding semiconductor wafer, the wet-etching is applied to the ground side of the semiconductor wafer chemically by using etching solution such as hydrofluoric acid, as shown in Japanese Patent 9-223680 (A).

The grinding-and-etching system uses a strong acid such as hydrofluoric acid. Disadvantageously use of such a strong acid is apt to produce a lot of NOx or other unwholesome gas, causing a significant environmental pollution.

To prevent such an environmental pollution it is necessary to install in the site an extra equipment, which is isolated from the surrounding space, and such installations are intolerably expensive.

In addition, used etching solution must be carefully treated prior to drainage as a waste, and accordingly the running fee costs much.

There has been, therefore, an increasing demand for an installation which permits efficient removal of strains from post-grinding semiconductor wafers without causing any environmental pollution.

### SUMMARY OF THE INVENTION

To meet such demand a grinding-and-etching system for grinding a thin plate-like object to a desired thickness according to the present invention comprises: chuck table means for fixedly holding the plate-like object; grinder means for grinding the plate-like object held on the chuck table means; washing means for washing the post-grinding plate-like object; and dry-etching means for dry-etching the plate-like object thus washed.

The grinding-and-etching system may include: a cassette storage for storing a plurality of pre-grinding plate-like objects, which are laid on each other in the storage; first transporting means for taking out plate-like objects from the cassette storage one by one; centering means for centering the plate-like object thus taken out; second transporting means for transferring the so centered plate-like object to the chuck table means; third transporting means for transferring the post-grinding plate-like object from the chuck table means to the washing means; and fourth transporting means for transferring the washed plate-like object to the dry-etching means.

The dry-etching means may include, in a dry-etching treatment chamber, a holding unit for holding the plate-like object, a pair of high-frequency electrodes for generating plasma within the dry-etching treatment chamber, a high-frequency power supply-and-resonator for applying a high-frequency voltage to the high-frequency electrodes, a gas supply for supplying the dry-etching treatment chamber with etching gas, and a gas exhausting unit for purging the gas from the dry-etching treatment chamber.

The holding unit may include a cooling equipment for cooling plate-like objects, and the gas exhausting unit may include with a filter equipment for neutralizing the etching gas.

The plate-like object may be a silicon substrate, and the etching gas is an attenuated fluorine gas.

The silicon substrate may have a plurality of circuits formed on one side, leaving the other side of the silicon substrate free of circuit patterns for grinding and dry-etching.

Thanks to use of dry-etching for removing strains from post-grinding semiconductor wafers, no environmental pollution can be caused, and therefore, no extra installations required for disposal of unwholesome waste, still permitting efficient etching on post-grinding semiconductor wafers for removal of strains.

Other objects and advantages of the present invention will be understood from the following description of a grinding-and-etching system according to one preferred embodiment of the present invention.

### BRIEF DESCRIPTION OF THE DRAWING

FIG. 1 is a perspective view of a grinding-and-etching apparatus according to the present invention;

FIG. 2 illustrates the transferring chamber, treatment chamber and fourth transporting means of the grinding-and-etching apparatus;

FIG. 3 illustrates the treatment chamber and gas supply-and-exhaustion annex in the dry-etching means; and

FIG. 4 illustrates how a semiconductor wafer is ground on its rear side.

### DETAILED DESCRIPTION OF PREFERRED EMBODIMENT

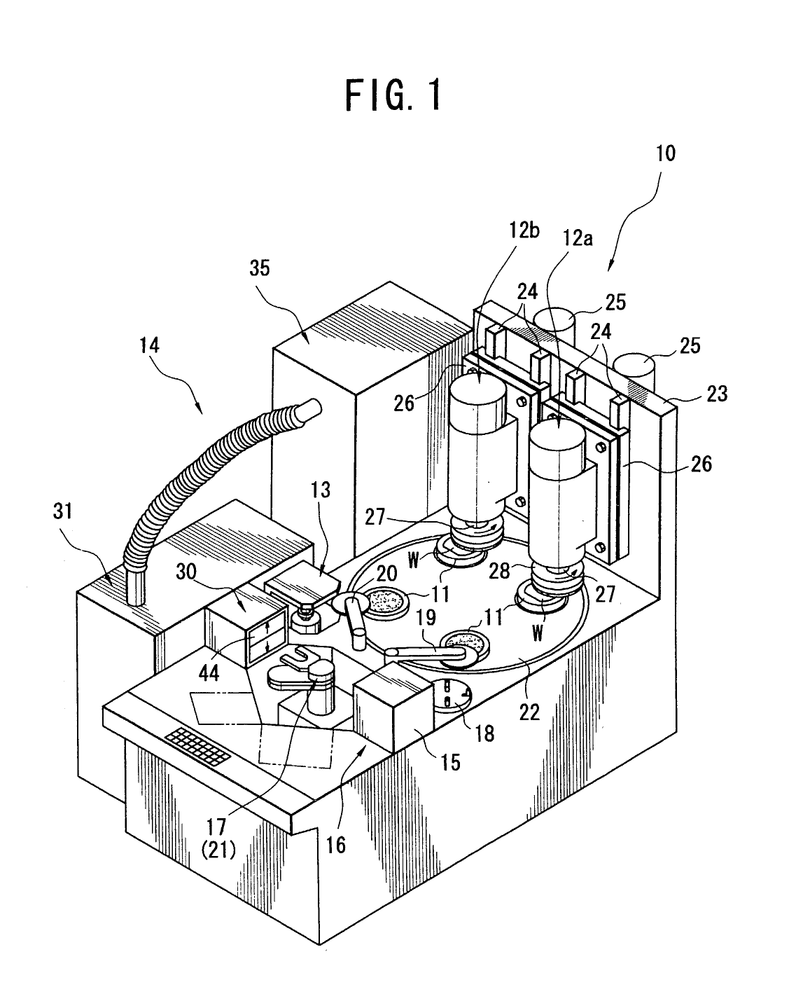

Referring to FIG. 1, a grinding-and-etching apparatus 10 for grinding plate-like objects to a desired thickness comprises chuck tables 11 for fixedly holding plate-like objects, first and second grinder means 12a and 12b for grinding the plate-like object W held on the chuck table 11, washing means 13 for washing the post-grinding plate-like objects and dry-etching means 14 for dry-etching the plate-like objects thus washed. The grinding-and-etching apparatus further includes a storage 16 in the form of cassette 15 for storing a plurality of pre-grinding wafer-thin, plate-like objects, first transporting means 17 for taking out plate-like objects from the cassette storage 15 one by one, centering means 18 for centering the plate-like object thus taken out, second transporting means 19 for transferring the so centered plate-like object W to a selected chuck table 11, third transporting means 20 for transferring the post-grinding plate-like object W from the chuck table 11 to the washing means 13 and fourth transporting means 21 for transferring the washed plate-like object to the dry-etching means 14.

Assume that the plate-like object is a silicon substrate having a plurality of circuit patterns formed on its front side, and a large number of such silicon wafers W are laid on each other with their rear sides up. The first transporting means 17 takes out silicon wafers W one by one to put it on the centering means 18. After being placed at the center, the wafer W is sucked onto the second transporting means 19, and the second transporting means 19 turns to bring the wafer W to a selected chuck table 11, putting it there to be fixedly held.

The turntable 22 turns a predetermined angle to place the wafer W under the first grinder means 12a to subject its upper side to the coarse grinding.

After finishing the coarse grinding, the turntable 22 turns another predetermined angle to place the wafer W under the second grinder means 12b, and then the wafer W is subjected to the fine grinding.

As seen from FIG. 1, each grinder means 12a or 12b is movably attached to an upright wall 23. Specifically a pair of parallel rails 24 are fixed to the upright wall 23, and a slide 26 bearing the grinder means 12a or 12b rides on the parallel rails 24 to be moved up and down by an associated drive 25.

Each grinder means 12a or 12b has a coarse or fine grindstone fixed to its wheel 29a or 29b. Such wheel is fixed to the spindle 27 of the grinder 12a or 12b via an associated mount 28.

After finishing the fine-grinding of the wafer W, the turntable 22 rotates still another predetermined angle to bring the chuck table 11 close to the third transporting means 20, which, in turn, transfers the wafer W to the washing area 13. After being washed there, the wafer W is transferred to the dry-etching means 14. In this particular embodiment the first transporting means 17 is used as the fourth transporting means 21. As a matter of course a separate transporting means may be used.

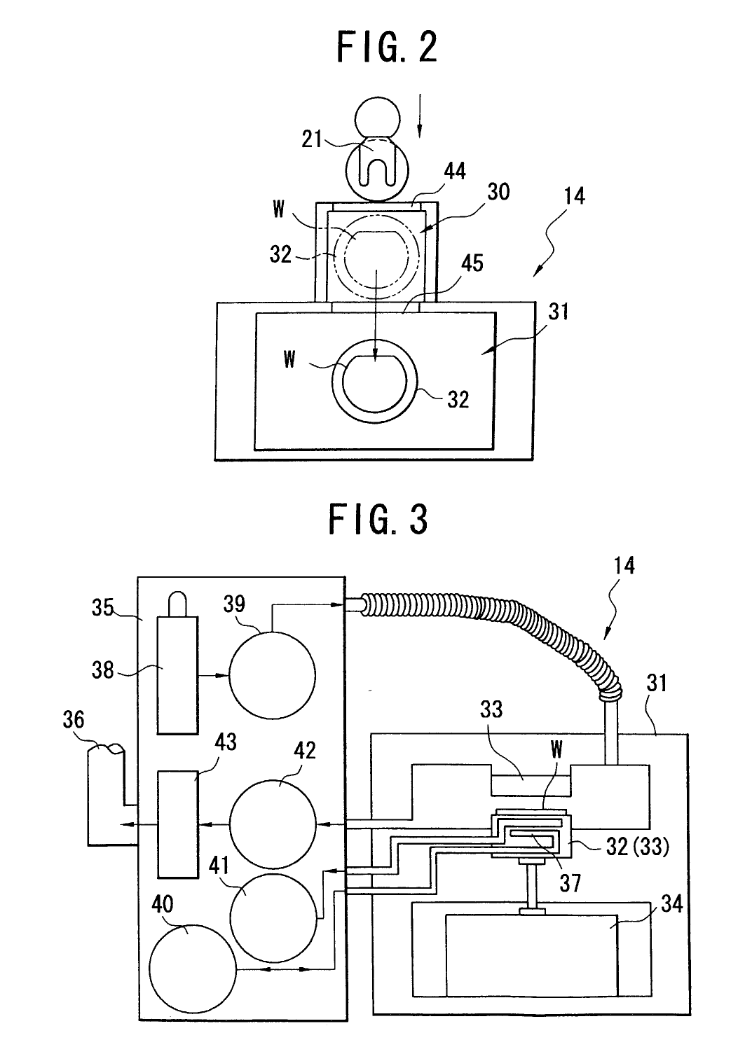

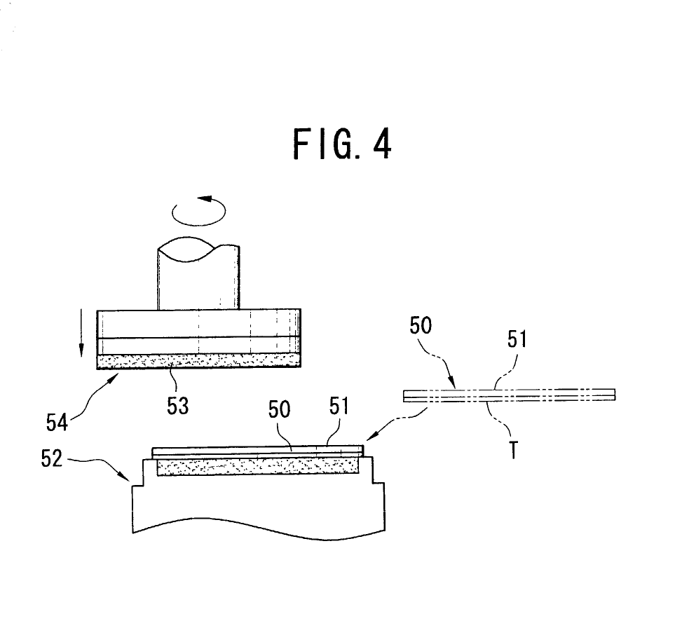

Referring to FIGS. 2 and 3, the dry-etching means 14 comprises a taking-in and out chamber 30, a dry-etching treatment chamber 31, a holder-and-carrier 32 for holding and carrying a wafer W from the taking-in and out chamber 30 to the dry-etching chamber 31 and vice versa, a pair of high-frequency electrodes 33 for generating plasma within the dry-etching treatment chamber 31, a high-frequency power supply-and-resonator 34 for applying a high-frequency voltage between the opposite high-frequency electrodes, a gas supply 35 for supplying the dry-etching treatment chamber 31 with an etching gas, and a gas exhausting section 36 for purging the gas from the dry-etching treatment chamber 31. In this particular embodiment, the holder-and-carrier 32 is used as one of the paired high-frequency electrodes 33, and it is equipped with a cooling unit 37 for cooling the wafer W.

Referring to FIG. 3, the gas supply 35 includes a tank 38 for storing etching gas, a pumping unit 39 for directing the etching gas from the tank 38 to the etching chamber 31, a coolant circulator 40 for supplying cooling water to the cooling unit 37, a suction pump 41 for applying a negative pressure to the holder-and-carrier 32, another suction pump 42 for drawing the etching gas from the treatment chamber 31 and a filter 43 for neutralizing and exhausting the etching gas.

The wafer W thus ground and washed is held and carried by the fourth transporting means 21 in the direction indicated by the arrow in FIG. 2, to enter the taking-in and out chamber 30 with its gate 44 open, and the wafer W is put on the holder-and-carrier 32 with its rear side up. The first gate 44 is closed to evacuate the taking-in and out chamber 30.

Then, the second gate 45 of the dry-etching treatment chamber 31 is opened to allow the holder-and-carrier 32 to enter the treatment chamber 31. Thus, the wafer W is put in the treatment chamber 31.

The pump 39 is put in operation so that the treatment chamber 31 is filled with an attenuated fluorine gas, and the high-frequency power supply-and-resonator 34 is put in operation to apply a high-frequency voltage between the opposite high-frequency electrodes 33. Thus, plasma is established to cover the rear side of the wafer W. The wafer W is subjected to the dry-etching while the coolant circulator 40 supplies the cooling unit 37 with the cooling water. The strains are removed from the rear side of the wafer W.

After completing the etching, the etching gas is drawn from the treatment chamber 31 by the suction pump 42 to be neutralized by the filter 43, and then, the neutralized etching gas is exhausted. The treatment chamber 31 is evacuated, and then the second gate 45 is opened, allowing the holder-and-carrier 32 along with the etched wafer W to enter the taking-in and out chamber 30, and the second gate 45 is closed.

After the wafer W is put in the taking-in and out chamber 30, the first gate 44 is opened, thus allowing the fourth transporting means 21 to carry the wafer W from the taking-in and out chamber 30 to the cassette 15.

The grinding-and-etching apparatus 10 permits a series of grinding, washing and dry-etching to be continued without intermission, accordingly improving the working efficiency, and advantageously, no strong acid such as hydrofluoric acid is used in etching, not producing any unwholesome gas such as NOx, which if produced, will cause environmental pollution. No expensive installations, therefore, are required for disposal of unwholesome waste, which may increase the running cost significantly.

The present invention is described as being applied to the grinding and etching of silicon semiconductor wafers, but it should be understood that the present invention be equally applied to the grinding and etching of gallium arsenic semiconductor or other chemical compound semiconductor, and plate-like objects such as glass substrates. The grinding-and-etching system according to the present invention can be used in grinding diced semiconductor wafers on their rear sides.

The advantages provided by the present invention are:

1) the dry-etching of wafers following the grinding without intermission, removing instantly from the wafers the strains which are caused in grinding;

2) hydrofluoric acid or any other strong acid are not used, which chemical substance if used, will produce an unwholesome gas to cause environmental pollution;

3) no extra installations required for disposal of such unwholesome waste, and accordingly significant reduction of the running cost attained.

What is claimed is:

1. A grinding-and-etching system for grinding thin plate-like objects to a desired thickness comprising:
chuck table means for fixedly holding plate-like objects;
grinder means for grinding plate-like objects held on the chuck table means;
washing means for washing the post-grinding plate-like objects; and
dry-etching means for dry-etching the plate-like objects thus washed.

2. A grinding-and-etching system according to claim 1, wherein it includes:
a cassette storage for storing a plurality of pre-grinding plate-like objects, which are laid on each other in the storage;
first transporting means for taking out plate-like objects from the cassette storage one by one;
centering means for centering the plate-like object thus taken out;
second transporting means for transferring the so centered plate-like object to the chuck table;
third transporting means for transferring the post-grinding plate-like object from the chuck table to the washing means; and
fourth transporting means for transferring the washed plate-like object to the dry-etching means.

3. A grinding-and-etching system according to claim 2, wherein the dry-etching means includes, in a dry-etching treatment chamber,
a holding unit for holding the plate-like object,
a pair of high-frequency electrodes for generating plasma within the dry-etching treatment chamber,
a high-frequency power supply-and-resonator for supplying the high-frequency electrode with high-frequency energy,
a gas supply for supplying the dry-etching treatment chamber with an etching gas, and
a gas exhausting unit for purging the gas from the dry-etching treatment chamber.

4. A grinding-and-etching system according to claim 3, wherein the holding unit includes a cooling equipment for cooling plate-like objects, and the gas exhausting section has a filter equipped for neutralizing the etching gas.

5. A grinding-and-etching system according to claim 4, wherein the plate-like object is a silicon substrate, and the etching gas is an attenuated fluorine gas.

6. A grinding-and-etching system according to claim 5, wherein the silicon substrate has a plurality of circuits formed on one side, leaving the other side free of circuit patterns for grinding and dry-etching.
